(19) United States
(12) Patent Application Publication
(10) Pub. No.: US 2025/0106164 A1
(43) Pub. Date: Mar. 27, 2025

(54) SYSTEM AND METHODS FOR MESH TREE WIDE TRAFFIC METERING AND SHAPING

(71) Applicant: Cisco Technology, Inc., San Jose, CA (US)

(72) Inventors: Anirban Karmakar, Ecublens (CH); Thomas Vegas, Gland (CH); Vincent Cuissard, Eteaux (FR)

(21) Appl. No.: 18/475,913

(22) Filed: Sep. 27, 2023

(51) Int. Cl. H04L 41/0896; H04L 47/215

(52) U.S. Cl. CPC H04L 47/215; H04W 28/22; H04W 84/18

(57) ABSTRACT

A system and method are provided for allocating bandwidth and metering data flows within a wireless mesh-tree network. The network includes a wireless LAN controller (WLC), a root access point (RAP), and mesh access points (MAPs), which are arranged in respective hop levels corresponding to the number of links a given MAP is removed from the RAP. The WLC allocates available data rates (ADRs) to the respective MAPs, and each MAP then apportions its ADR among various origination types of data flowing through the given MAP (e.g., backhaul, ethernet-bridged, and client data types). The MAPs can use a token bucket filter (TBF)-like mechanism to enforce this apportionment. WiFi multi-media (WMM) based access classes can be used to shape the data flows (e.g., an NC access class assigned to topology maintenance traffic ensures it is fed directly into a WMM queue).

### BACKGROUND

In a mesh network, several devices can share one channel and contend for access to the shared channel. In this case, only one device transmits signals at any given time. This can lead to a build-up of data in the buffers of the other devices, especially in the devices that are given lower priority in contention or that receive data from multiple devices. Accordingly, various bottlenecks for traffic flow can develop at one or more Access Points (APs) in the mesh network, particularly as the size and the complexity of the mesh network grows.

Thus, current mesh networks cannot evaluate the overall mesh tree and implement traffic metering and shaping adjusted to the available backhaul bandwidth based on the tree structure. Additionally, current mesh networks lack the capability for priority handling of traffic at the mesh node based on device and/or origination type of the data (e.g., whether the data is of a backhaul (BH) data, a client data, or ethernet-bridged data).

Even when the mesh nodes classify and shape traffic into WMM access classes, the traffic at the mesh node is not metered. Further, current mesh networks lack feedback loops. Consequently, a situation can occur in which ethernet-bridged traffic consumes the entire network bandwidth, preventing all other data flows, which is problematic because preventing the flow of control traffic can destabilize the mesh network.

Accordingly, improved mesh-tree networks are desired to remedy the above-noted deficiencies of current mesh networks.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of a first example of a mesh-tree network, in accordance with some embodiments.

FIG. 2 illustrates a block diagram of a second example of a mesh-tree network, in accordance with some embodiments.

FIG. 3 illustrates a flow diagram of an example of a method of metering and shapping data flows in a mesh-tree network, in accordance with some embodiments.

FIG. 4 illustrates a block diagram of a third example of a mesh-tree network, in accordance with some embodiments.

FIG. 5 illustrates a block diagram of an example of a token bucket filter, in accordance with some embodiments.

FIG. 6 illustrates a block diagram of an example of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

In one aspect, a method for allocating bandwidth and metering data flows in a mesh-tree network that includes a root access point (RAP) and mesh access points (MAPs). The MAPs include a first set of the MAPs at a one-hop level and a second set of the MAPs at a two-hop level. The method includes allocating, by a controller, available data rates (ADRs) for the respective MAPs, wherein, for each of the MAPs, the ADR allocated to a given MAP is a predefined fraction of a total ADR of the RAP. The method further includes apportioning, at a given MAP, the ADR allocated to the given MAP based on an origination type of data flowing through the given MAP, wherein a first portion of the ADR of the given MAP is designated for a first origination type and a second portion of the ADR of the given MAP is designated for a second origination type.

In another aspect, the method may also include apportioning, at the given MAP, the ADR allocated to the given MAP by: determining a first number of tokens that are allocated for the first origination type and a second number of tokens that are allocated for a second origination type; and transmitting data through the given MAP by: limiting an amount of data of the first origination type flowing through the given MAP to less than or equal to the first number of tokens, and limiting an amount of data of the second origination type flowing through the given MAP to less than or equal to the second number of tokens.

In another aspect, the method may also include apportioning, at the given MAP, the ADR allocated to the given MAP among three origination types of data, which are (1) a backhaul (BH) data type, (2) an ethernet-bridged data type, and (3) a client data type, the ADR of the given MAP being apportioned by: providing, at predefined times, a first number of tokens for the BH data type, a second number of tokens for the control data type, and a third number of tokens for the client data type; limiting, during a predefined time period, an amount of BH data transmitted through the given MAP to be less than or equal to the first number of tokens; limiting, during the predefined time period, an amount of ethernet-bridged data transmitted through the given MAP to be less than or equal to the second number of tokens; and limiting, during a predefined time period, an amount of client data transmitted through the given MAP to be less than or equal to the third number of tokens.

In another aspect, the method may also include transmitting the data through the given MAP by metering data packets in accordance with the apportionment of the ADR allocated to the given MAP; and assigning the metered data packets to WiFi multi-media (WMM) based access classes to shape data traffic, and labeling topology maintenance traffic with a predefined WMM based access class that ensures the topology maintenance traffic is fed directly into a WMM queue.

In another aspect, the method may also include shaping traffic within the wireless mesh tree by assigning topology maintenance data traffic to an access class that ensures that the topology maintenance data traffic will be fed directly into a data queue.

In another aspect, the method may also include that the predefined fraction of the total ADR of the RAP that is allocated as the ADR of the given MAP is determined based, at least in part, on a hop level of the given MAP, a number of neighbors of the given MAP, and a number of clients within the wireless mesh-tree network.

In another aspect, the method may also include that the enforcing, by the given MAP, of the allocated ADRs of children of the given MAP by: communicating to the given MAP the allocated ADRs of children of the given MAP; and pulling, by the given MAP, respective quantities of data packets from the respective children of the given MAP, the respective quantities of data packets being pulled corresponding to the respective located ADRs of the respective children of the given MAP.

In another aspect, the method may also include that the allocated ADRs of children of the given MAP are enforced using a request to send/clear to send (RTS/CTS) protocol.

In another aspect, the method may also include that the quantity of data packets being pulled from a given child is apportioned according to origination types of the data, the origination types comprising a backhaul (BH) data type and a client data type.

In another aspect, the method may also include independently pulling data packets between hop levels of the wireless mesh-tree network by: selectively pulling, at the given MAP, uplink data packets from respective children of the given MAP, and when a pulled child of the given MAP lacks uplink data packets increasing a bandwidth of data packets pulled from another of the children of the given MAP, wherein the children of the given MAP are access points (APs) or client devices in direct communication with the given MAP that are one hop level below the given MAP.

In another aspect, the method may also include recursively pulling data packets between hop levels of the wireless mesh-tree network by: receiving, at the given MAP, a pulling instruction from a parent access point (AP) of the given MAP, the pulling instruction instructing the given MAP to send a specified quantity of data packets of a specified origination type to the parent AP; and pulling, in response to the pulling instruction, uplink data packets to the given MAP, the uplink data packets being pulled from one or more children of the given MAP, wherein the children of the given MAP are access points (APs) or client devices in direct communication with the given MAP that are one hop level below the given MAP.

In another aspect, the method may also include class-aware pulling of data packets within the wireless mesh-tree network by: determining, by the children of the given MAP, portions of the ADRs allocated to the children that are apportioned to respective origination types; communicating, to the given MAP, the apportionments to the respective origination types of the ADRs allocated to the children; and enforcing, at the given MAP, the apportionments to the respective origination types of the ADRs allocated to the children by selectively pulling data packets from the children in accordance with the apportionments to the respective origination types of the ADRs allocated to the children.

In another aspect, the method may also include receiving an instruction to increase a bandwidth allocated to a predefined class of data; and increasing a rate of pulling, from the children to the given MAP, data packets corresponding to the predefined class of data.

In another aspect, the method may also include reserving portions of the ADRs for the respective MAPs for an origination type of control data, the reserved portions of the ADR being determined to provide sufficient bandwidth for the control data to ensure stable operation of the wireless mesh-tree network.

In one aspect, a computing apparatus includes a processor. The computing apparatus also includes a memory storing instructions that, when executed by the processor, configure the apparatus to perform the respective steps of any one of the aspects of the above-recited methods.

In one aspect, a computing apparatus includes a processor. The computing apparatus also includes a memory storing instructions that, when executed by the processor, configure the apparatus to allocate, by a controller, available data rates (ADRs) for the respective MAPS, wherein, for each of the MAPs, the ADR allocated to a given MAP is a predefined fraction of a total ADR of the RAP; and apportion, at a given MAP, the ADR allocated to the given MAP based on an origination type of data flowing through the given MAP, wherein a first portion of the ADR of the given MAP is designated for a first origination type and a second portion of the ADR of the given MAP is designated for a second origination type.

In another aspect of the computing apparatus, the stored instructions, when executed by the processor, further configure the apparatus to apportion the ADR allocated to the given MAP by: determining a first number of tokens that are allocated for the first origination type and a second number of tokens that are allocated for a second origination type; and transmitting data through the given MAP by: limiting an amount of data of the first origination type flowing through the given MAP to less than or equal to the first number of tokens, and limiting an amount of data of the second origination type flowing through the given MAP to less than or equal to the second number of tokens.

In another aspect of the computing apparatus, the stored instructions, when executed by the processor, further configure the apparatus to transmit the data through the given MAP by metering data packets in accordance with the apportionment of the ADR allocated to the given MAP; and assign the metered data packets to WiFi multi-media (WMM) based access classes to shape data traffic, and labeling topology maintenance traffic with a predefined WMM based access class that ensures the topology maintenance traffic is fed directly into a WMM queue.

In another aspect of the computing apparatus, the stored instructions, when executed by the processor, further configure the apparatus to shape traffic within the wireless mesh tree by assigning topology maintenance data traffic to an access class that ensure that the topology maintenance data traffic will be fed directly into a data queue.

In another aspect of the computing apparatus, the predefined fraction of the total ADR of the RAP that is allocated as the ADR of the given MAP is determined based, at least in part, on a hop level of the given MAP, a number of neighbors of the given MAP, and a number of clients within the wireless mesh-tree network.

In another aspect of the computing apparatus, the stored instructions, when executed by the processor, further configure the apparatus to: enforce, by the given MAP, the allocated ADRs of children of the given MAP by: communicating to the given MAP the allocated ADRs of children of the given MAP; and pulling, by the given MAP, respective quantities of data packets from the respective children of the given MAP, the respective quantities of data packets being pulled corresponding to the respective located ADRs of the respective children of the given MAP.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for mesh-tree networks having the capability to evaluate the overall mesh tree and implement traffic metering and shaping adjusted to the available backhaul bandwidth based on the tree structure. Additionally, the disclosed technology addresses the need in the art for mesh-tree networks that have the capability for priority handling of traffic at the mesh node based on the device and/or origination type of the data (e.g., whether the data is of a backhaul (BH) data, a client data, or ethernet-bridged data).

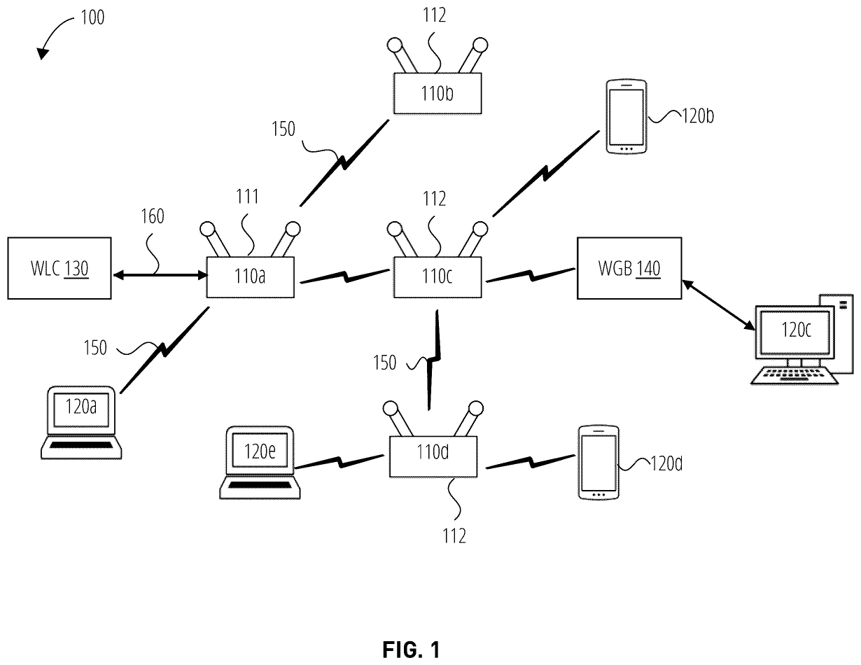

FIG. 1 illustrates an example mesh network 100, according to certain examples of the present disclosure. The mesh network 100 includes several access points (APs), including AP 110a, AP 110b, AP 110c, and AP 110d, which provide network connectivity to one another and User Equipment Devices (UED) (e.g., UED 120a, UED 120b and UED 120c). FIG. 1 illustrates a non-limiting example of a deployment of a partially connected mesh network, and the present disclosure is applicable to other deployments with more or fewer APs 110 and UEDs 120 in different arrangements, including fully connected deployments in which every node may communicate with every other node.

An AP may include various networking devices configured to provide wireless networks according to various networking standards or Radio Access Technologies (RAT) (e.g., IEEE 802.11 or “WiFi” networks, BLUETOOTH® networks, “cellular” (including various generations and subtypes thereof, such as Long Term Evolution (LTE) and Fifth Generation New Radio (5G NR)) networks, Citizens Broadband Radio Service (CBRS) networks, proprietary networks).

Similarly, a UED may include any computing device that is configured to wirelessly connect via a wireless link 150 to one or more APs. Example UED 120 can include, but are not limited to, smart phones, feature phones, tablet computers, laptop computers, desktop computers, Internet of Things (IoT) devices, and the like. Various standards may refer to a UED as a client device, user equipment, mobile station (STA).

Specific APs 110 in the mesh network 100 include a Root AP (RAP) 111 and one or more Mesh APs (MAP) 112. A RAP 111, such as the first AP 110a, is connected to a wireless Local Area Network (LAN) controller (WLC) 130, and provides a wired link 160 for all of the wireless traffic over the mesh network to travel out of the network (e.g., over a wired channel to an external network, such as the Internet). The MAPs 112, such as the second through fourth APs 110b-d, provide forwarding services from UEDs and/or other MAPs 112 to the RAP 111 and/or to other devices within the mesh network. For example, a communication pathway for the third UED 120c to an external network would include the fourth AP 110 d, the third AP 110c, and the first AP 110a. In an additional example, a communication pathway for the third UED 120c to the first UED 120a would include the fourth AP 110d and the third AP 110c.

The WLC 130 manages the configuration of the APs in the mesh network 100, and thereby ensures that the APs do not interfere with each other and that traffic is properly formatted for routing within the mesh network. In various embodiments, the WLC 130 can control the power levels at which the various APs 110 broadcast, and may assign available data rates (ADRs) to the APs to allocate data bandwidths among the APs 110 and/or the available spectrum used by the mesh network. In various embodiments, the WLC 130 assigns the ADRs for communication amongst the devices in the mesh network. In some embodiments, the WLC 130 is connected via a wired link 160 and/or a network switch to the RAP 111.

In various embodiments, the UEDs can directly communicate with the APs, or a Work Group Bridge (WGB) 140 can provide wireless connectivity to a UED connected via a wired link to the WGB 140. For example, a user may connect a desktop computer that lacks an integrated wireless communications interface to a WGB 140 via an Ethernet cable to use the wireless communications interfaces of the WGB 140 to connect to a wireless network. In various embodiments, the WGB 140 may provide access to the wireless network to one or several UEDs, and acts as a wired access point that manages and directs the traffic to/from the various connected UEDs to provide wireless access connectivity to wired clients via a single wireless connection to an AP. The AP to which the WGB 140 wirelessly connects treats the WGB 140 as a single wireless client regardless of the number of UEDs connected by wire to the WGB 140. UEDs and WGBs can collectively be referred to as client devices.

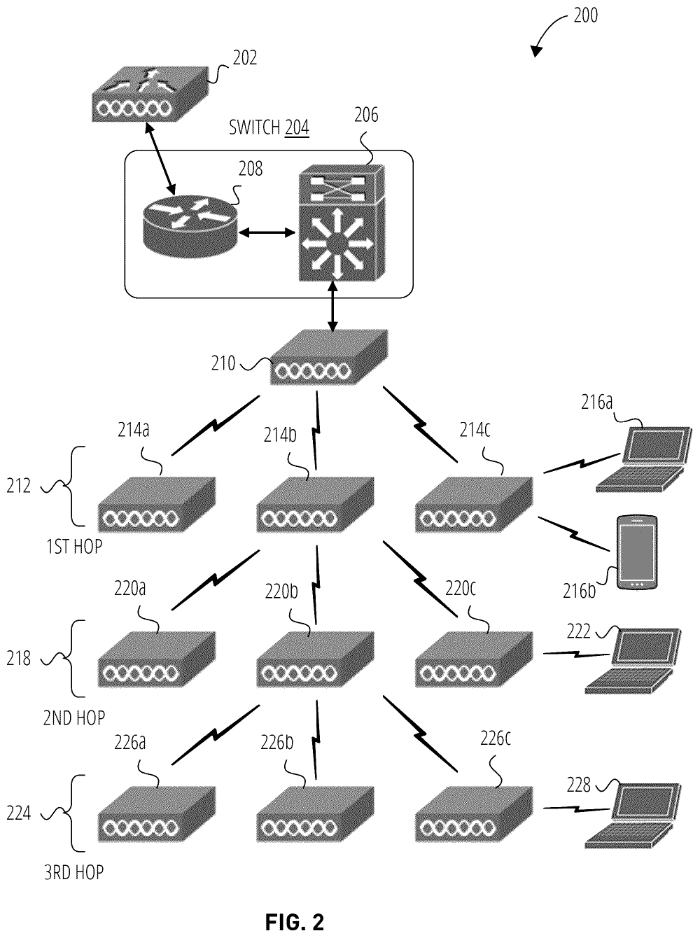

FIG. 2 illustrates an example of a mesh-tree network 200. The mesh-tree network 200 includes a WLC 202, a switch 204, which includes a route-switch processor 206 and a router 208), a route access point (RAP) 210, and various mesh access points (MAPs), which includes MAP-1,1 214a, MAP-1,2 214b, MAP-1,3 214c, MAP-2,1 220a, MAP-2,2 220b, MAP-2,3 220c, MAP-3,1 226a, MAP-3,2 226b, and MAP-3,3 226c).

The MAPs are arranged according to respective hop levels corresponding to how many connections a given MAP is removed from the RAP 210. For example, a 1st hop 212 includes MAP-1,1 214a, MAP-1,2 214b, and MAP-1,3 214c. The nomenclature of MAP-i,j indicates that a given MAP is the jth MAP in the ith hop level. Each of the MAPs in the 1st hop 212 can have client devices. In the non-limiting example of FIG. 2, this aspect is illustrated by MAP-1,3 214c having client-1,1 216a and client-1,2 216b connected to MAP-1,3 214c via wireless links.

In the non-limiting example illustrated in FIG. 2, the 2nd hop 218 includes MAP-2,1 220a, MAP-2,2 220b, and MAP-2,3 220c, all of which are connected to MAP-1,2 214b via wireless link. As with the 1st hop 212, each of the MAPs in the 2nd hop 218 can have client devices. In the non-limiting example of FIG. 2, this aspect is illustrated by MAP-2,3 220c being connected to client-2 222 via a wireless link.

Similarly, the 3rd hop 2248 includes MAP-3,1 226a, MAP-3,2 226b, and MAP-3,3 226c, all of which are connected to MAP-2,2 220b via wireless link. Here again, each of the MAPs in the 3rd hop 224 can be connected to client devices, which is exemplified in FIG. 2 by MAP-3,3 226c being connected to client-3 228 via a wireless link.

In one common use case for a mesh network, one radio channel is provided, and all nodes communicate with each other on this one radio channel. For data to be relayed up the hop levels from mesh node to mesh node, the data is repeatedly transmitted and received between nodes of the hop levels in a store-and-forward manner. That is, a node first receives the data and then retransmits it. These operations cannot occur simultaneously as they will cause con-channel interference due to there being only a single channel.

Hence, if a node cannot send and receive at the same time, it loses ½ of its bandwidth as it attempts to relay packets up and down the wireless backhaul (BH) path (also referred to as relay path). A loss of ½ with each hop implies that after 4 hops, a user would be left with (½*½*½*½)= 1/16 of the max bandwidth available. This is a 1/(2^{N}) relationship where this equation defines the fraction of the bandwidth that is available to a user after N hops. In practice, a reduction in bandwidth with respect to hop level can be less than ½^{N}. Although it is recognized that mesh networks suffer from some bandwidth degradation with each hop, when the hops between mesh nodes are sufficiently separated spatially that simultaneous communications can be conducted between different hop levels without co-channel interference, then the bandwidth degradation can be given by 1/x^{N}, where 1≤x≤2.

Several different configurations of network meshes are contemplated for the system and methods disclosed here, including, but not limited to, a universal backhaul mesh, a dedicated backhaul mesh, and a serial backhaul mesh. In a universal backhaul mesh, the mesh network uses one radio channel both to service clients and to provide the mesh.

The dedicated backhaul mesh has a dedicated radio (channel) for backhaul and another one for client access. For example, a 2.4 GHz IEEE 802.11 b/g radio can be used for communicating with client devices and an IEEE 802.11a (5 GHZ) radio can be used exclusively for backhaul communications. Further, in this architecture, all mesh nodes can share the same channel for connectivity. The serial backhaul mesh provides a separate backhaul channel at each hop. The AP ensures all backhauls are on non-interfering channels. Consequently, this architecture provides the best mesh backhaul performance and these three architectures.

As discussed above, depending on the configuration of radios used of the mesh network 100, the bandwidth and available data rate (ADR) will be reduced, especially as the hop level becomes greater. This bandwidth reduction, which is caused by bandwidth/channel sharing, limits the amount of backhaul traffic allowed at each hop and is compounded at each hop.

Consider, for example, a case in which there are C simultaneous clients per mesh node, packets coming from the client at the mesh node farthest from the backhaul have a 1/C bandwidth share as they attempt to reach the closest mesh node. Aggregated traffic from this node gets a 1/C share again as it attempts to reach the next mesh node. The bandwidth share for the original packet is then reduced by the factor 1/C². This compounding continues until the Ethernet backhaul is reached.

For example, in the case of a universal access mesh with just 2 clients (note: the mesh node is effectively another client), the bandwidth degradation per hop follows the 1/CN effect. In view of this, clients at the first hop level are allocated a fraction (e.g., ⅓) of the total ADR, clients at the second hop level are allocated a fraction of a fraction (e.g., ⅓*⅓= 1/9) of the total ADR, clients at the third hop level are allocated a fraction of a fraction of a fraction (e.g., ⅓*⅓*⅓= 1/27) of the total ADR, and so forth.

Based on the above reasoning, the formula to calculate bandwidth in a dedicated mesh backhaul case is given by

$${ADR}_{Hop} = \frac{{ADR}_{Total}}{{2}^{Hop} \times C \times {( M + 1 )}^{Hop}} ,$$

where ADR_{Total} is the total ADR that is available to the RAP, “Hop” refers to the number of hops (e.g., the hop level); “M” refers to the number of mesh neighbors on the backhaul that are sharing the bandwidth; and “C” refers to the number of clients on the radio.

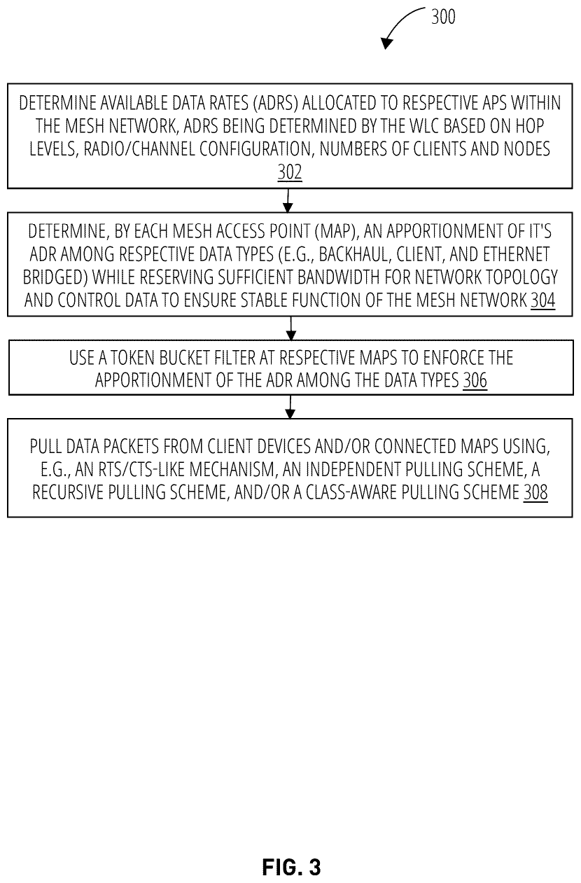

FIG. 3 illustrates an example method 300 for determining allocations of wireless resources (e.g., bandwidth) within a mesh network 100. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to certain non-limiting examples, step 302 of method 300 includes determining available data rates (ADRs) that are allocated to the respective APs within the mesh network. These ADRs are determined by the WLC 130 based on hop levels of the MAPs, the radio/channel configuration, the number of clients, and the number of neighboring MAPs. For example, the above calculation for ADR_{Hop} can be used by the WLC 130 to determine the ADR for a given MAP, and this determination can be performed for every MAP in the mesh network. Generally, the determination of the ADRs of the respective MAPs will include considerations of: (i) the available root uplink bandwidth (e.g., the ADR_{Total}); (ii) the number and locations of mesh nodes in the mesh tree; (iii) the number of neighbors at a given hop level; and (iv) the number and/character of wireless clients and wired clients at each mesh nod; and (v) the quantity of BH traffic at each mesh node.

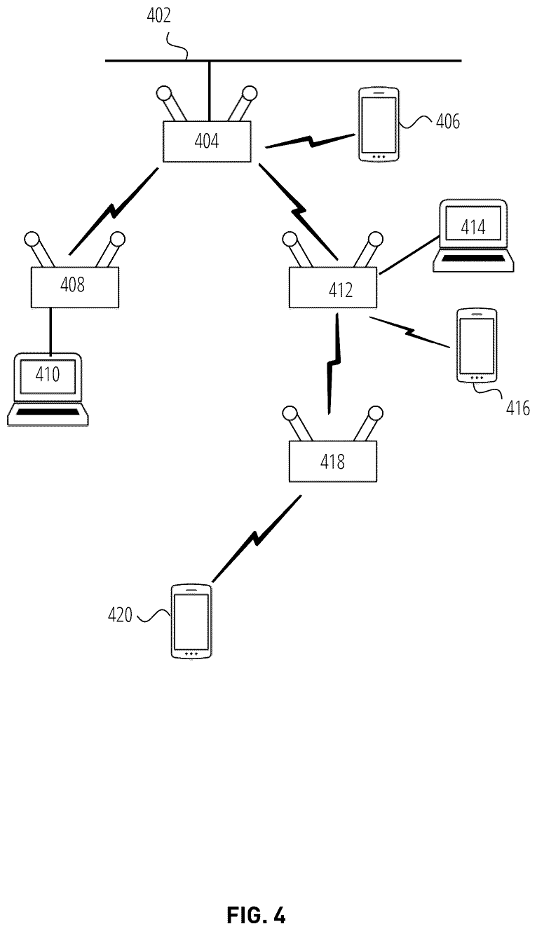

FIG. 4, which is discussed below, illustrates an example of this determination. The above calculation for ADR_{Hop} is for a particular example of the radio/channel configuration (e.g., the dedicated backhaul mesh), and the determination of ADRs for the respective MAPS can be adapted depending on the radio/channel configuration, as would be understood by a person of ordinary skill in the art. This allocation of ADRs to the respective MAPs can ensure a more equitable and/or uniform access of bandwidth to client devices of the mesh network. Otherwise, client devices at one hop level might receive a disproportionate amount of the bandwidth relative to client devices at another hop level.

According to certain non-limiting examples, the WLC 130 does not manage MAPs' bandwidth directly. Instead, the WLC 130 can use the ratios/formulas established above to determine the ADR for respective MAPs by using transmitted information (e.g., mesh control traffic) to correlate respective entities (e.g., wired UEDs and wireless UEDs) with the corresponding MAP to lookup the MAP in the mesh network hierarchy. For each MAP, the WLC 130 can take into account the resulting bandwidth that will be needed on its uplink BH. This can be performed, e.g., by computing the various bandwidths need for each entity found below a given MAP, and by establishing ADRs allocated to each of the given MAP's children for transmissions to the given MAP.

In step 304, each mesh access point (MAP) determines for itself how to apportion its ADR among respective data types (e.g., backhaul, client, and ethernet bridged). A problem that can arise in mesh networks is that one type of data (e.g., backhaul data) can overwhelm the system, preventing other types of data from being transmitted. This problem is especially significant when control messages for the mesh network topology are crowded out potentially destabilizing the mesh network. Thus, each MAP can be made responsible for metering and shaping data traffic through said MAP. This is done by each MAP setting aside or apportioning specified portions of the allocated ADR of the MAP for different data types (e.g., different origination types of the data). Examples, of origination types of the data include backhaul, client, and ethernet bridge data types.

According to certain non-limiting examples, step 306 of method 300 includes using a token bucket filter (TBF) at respective MAPs to enforce the apportionment of the ADR among the data types.

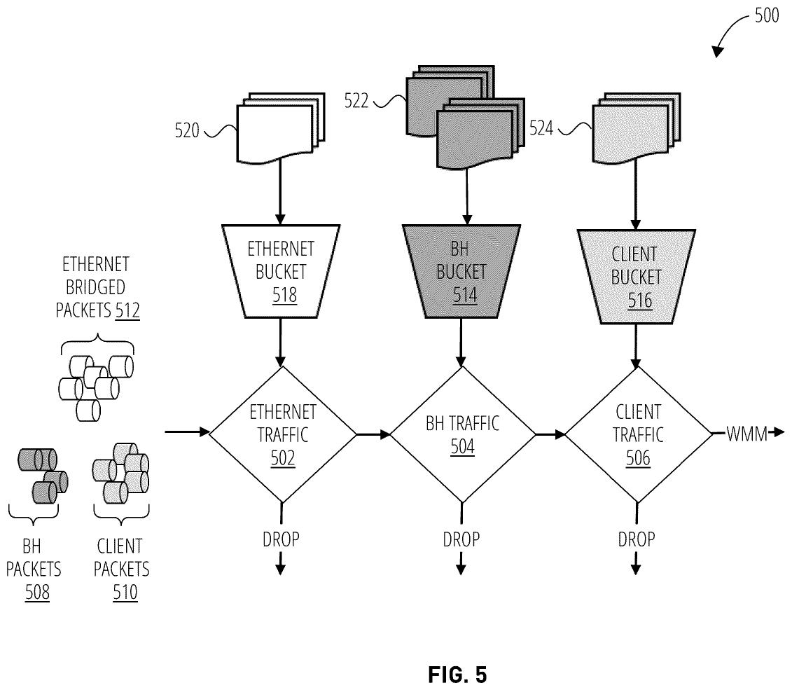

For example, the assigned ADR at a given MAP can be apportioned among BH data, wireless client data, and wired client data, which apportionment is enforced using a three-color token bucket filter (TBF) as discussed below with reference to FIG. 5 to determine allowed data packets. The TBF is used to perform metering of the allowed packets with respect to the classes of client data, and the allowed data packets are fed to WiFi Multimedia (WMM) based access classes to shape the traffic. Additionally, topology maintenance traffic can be assigned to the WMM class of NC, thereby ensuring that it will be fed directly into the WMM queue. Accordingly, sufficient bandwidth is reserved for network topology and control data to ensure stable function of the mesh network.

Although the allocation of the ADRs to MAPs can be based on a centralized calculation at the WLC 130, the metering of the data traffic among classes of data is decentralized and distributed among the MAPs of the mesh network. That is, the WLC determines the ADRs of the MAPs by taking into account the respective depths of the MAPs within the tree. For example, the overall bandwidth need on a given collision domain/channel for an entity (e.g., a MAP of UED) can be N times the entity bandwidth, with N being the level of the entity (e.g., the level of the access point (AP) for control traffic, or level of the AP of the UED). For a given MAP, the forwarding traffic pattern can be that the transmitted BH traffic (i.e., TX) includes the received BH traffic (i.e., RX) from the next hop level (e.g., child MAPs) plus the uplink traffic from UEDs of the MAP (i.e., UEDs_self) plus the control traffic from the MAP (i.e., Control_self). Thus, the forwarding traffic pattern can be summarized as

$$TX = RX + UEDs\_self + Control\_self .$$

According to certain non-limiting examples, step 308 of method 300 includes pulling data packets from client devices and/or connected MAPs using, e.g., an RTS/CTS-like mechanism, an independent pulling scheme, a recursive pulling scheme, and/or a class-aware pulling scheme. As discussed above, traffic metering is distributed throughout the mesh network, rather than being centralized at the WLC 130.

For example, each MAP 112 can be responsible for enforcing the allocated TX bandwidth of its children. This enforcement can be achieved by making each MAP aware of the allocated ADRs from the WLC 130 for each of the MAP's immediate peers (e.g., parent and/or children). For example, a given MAP can be informed regarding the amount of uplink traffic that each of its peers/children can send to the given MAP. Further, the given MAP can be informed regarding the amount of downlink traffic that its peers/parent can send to the given MAP. Additionally, the given MAP can be informed regarding the fraction of the overall/total ADR that can be sent to the MAP via the collision domain/channel. Using a request to send/clear to send (RTS/CTS)-like mechanism the MAP can selectively pull data packets from its peers (e.g., children for uplink traffic and parent for downlink traffic). Further, the MAP can selectively pull data packet in correct proportions as dictated by the allocated ADRs. According to certain non-limiting examples, the given MAP pulls either from parent and/or child without any difference. Further, the given MAP is also being pulled for data packets by its peers (i.e., either a parent or a child).

For the case of pulling data packers from wired/wireless UEDs, as given MAP, which is an immediate AP for the UED, can drop traffic on the wired side, or wait for it to be pulled from the parent MAP. Then, if the traffic is not pulled, the given MAP can then drop the unpulled traffic.

The systems and methods disclosed herein can be performed using one or more variations for the pulling scheme, including, e.g., an independent pulling scheme, a recursive pulling scheme, and/or a class-aware pulling scheme.

In an independent pulling scheme, for example, each AP (e.g., RAP or MAPs) selectively pulls traffic from its children to itself. If one or more of the children from which traffic is pulled cannot send the requested quantity of data packets, the MAPs can then adapt by pulling more traffic from another of its children. This independent pulling mechanism allows for finer-grained adaptation of the mesh network and better utilizes the available bandwidth. Here, each MAP acts independently of the other MAPs in the network when pulling data from connected devices.

In a recursive pulling scheme, for example, a given MAP recursively pulls uplink data from its children in response to being pulled by the respective MAP's parent. Thus, a MAP a a 1st hop level will be pulled by the RAP, and in response pull its children at the 2nd hop level, resulting the the children then pulling their children at the 3rd hop level, and so on and so forth. Thus, when an AP pulls traffic from its child, that child in turn pulls data from its own child.

In a class-aware pulling scheme, for example, an AP is informed regarding the data type (e.g., class-based) apportionment of ADRs for entities of found below itself (e.g., children and grand children with greater hop levels). Based on this information, the AP can track the amount of traffic corresponding to different classes/data types that is received from the respective children (e.g., using TBF-like mechanism). The AP can then selectively pull a specific entity or class of entities for a particular data type.

FIG. 4 illustrates an example of a mesh network as an example of how method 300 can be applied. In this example, a wired uplink provides the RAP 404 with an ADR 402 of 800 Mbps. The 1st hop includes two MAPs (i.e., MAP-1,1 408 and MAP-1,2 412. In this example, MAP-1,1 408 has one client device (i.e., client-1,1,1 410) that is connected to MAP-1,1 408 via a wired link. Further, MAP-1,2 412 has two client devices (i.e., client-1,2,1 414 and client-1,2,2 416), and client-1,2,1 414 is connected to MAP-1,1 408 via a wired link, whereas client-1,2,2 416 is connected to MAP-1,1 408 via a wireless link. At the 2nd hop level, MAP-2,1 418 is a child of MAP-1,2 412, and MAP-2,1 418 has one client device (i.e., client-2,1,1 420) that is connected to via a wireless link.

In this example, the WLC determines the ADRs for each of the APs. The RAPs 404 receive the total ADR of the wired uplink (i.e., 800 Mbps). Based on the expression

$${ADR}_{Hop} = \frac{{ADR}_{Hop - 1}}{{2}^{Hop} \times C \times {( M + 1 )}^{Hop}} ,$$

the ADRs for MAP-1,1 408 and MAP-1,2 412 are both determined to be 200 Mbps (e.g., Hop=1, C=1, and M=1), and the ADR for MAP-2,1 418 is determined to be 50 Mbps (e.g., Hop=2, C=1, and M=0). [[*** INVENTORS PLEASE CAREFULLY REVIEW PREVIOUS SENTENCE]].

FIG. 5 illustrates an example of a three-color token bucket filter (TBF). Generally, a TBF is based on an analogy of a fixed capacity bucket into which tokens, representing a unit of data (e.g., one token corresponds to a single packet of predetermined size), are added at a fixed rate. When a packet is to be checked for conformance to the defined limits, the bucket is inspected to see if it contains sufficient tokens at that time. If so, the appropriate number of tokens are removed and the packet is passed into a transmission queue. When there are insufficient tokens in the bucket, then the packets are dropped. Alternatively, the packets may be buffered until sufficient tokens have accumulated in the bucket.

The flow thus contains traffic with an average rate up to the rate at which tokens are added to the bucket, and the maximum amount of data that can be transmitted at any given time is limited by the depth of the bucket.

According to certain non-limiting examples, the TBF 500 receives data packets of different types, which are illustrated here as BH packets 508, client packets 510, and ethernet bridged packets 512. Each type of data packets is illustrated using one of three different colors, hence the reference to “three-color” in the term “three-color TBF.” Tokens corresponding to the data types arrive in buckets at predetermined rates. For example, the ethernet tokens 520 arrive at the ethernet bucket 518 at a first rate, and the BH tokens 522 arrive at the BH bucket 514 at a second rate. Additionally, the client tokens 524 arrive at the BH client bucket 516 at a third rate. According to certain non-limiting examples, the maximum number of tokens can that can be contained in a given bucket is limited by the depth of the given bucket, preventing an excessive build-up of tokens in any given bucket.

The ethernet decision block 502 inquiries whether a given data packet is an ethernet-bridged type data packet, and if so, the ethernet decision block 502 next inquiries whether there are sufficient tokens in the ethernet bucket 518. If there are sufficient tokens, the ethernet bridged packet is added to the WMM queue with an appropriate WMM class for shaping the traffic. When insufficient tokens remain, the data packet is dropped.

The BH traffic decision block 504 inquiries whether a given data packet is a BH type data packet, and if so, the BH traffic decision block 504 next inquiries whether there are sufficient tokens in the BH bucket 514. If there are sufficient tokens, the BH type data packet is added to the WMM queue with an appropriate WMM class for shaping the traffic. When insufficient tokens remain, the data packet is dropped.

The client traffic decision block 506 inquiries whether a given data packet is a client type data packet, and if so, the 502 inquiries whether there are sufficient tokens in the client bucket 516. If there are sufficient tokens, the client type data packet is added to the WMM queue with an appropriate WMM class for shaping the traffic. When insufficient tokens remain, the data packet is dropped.

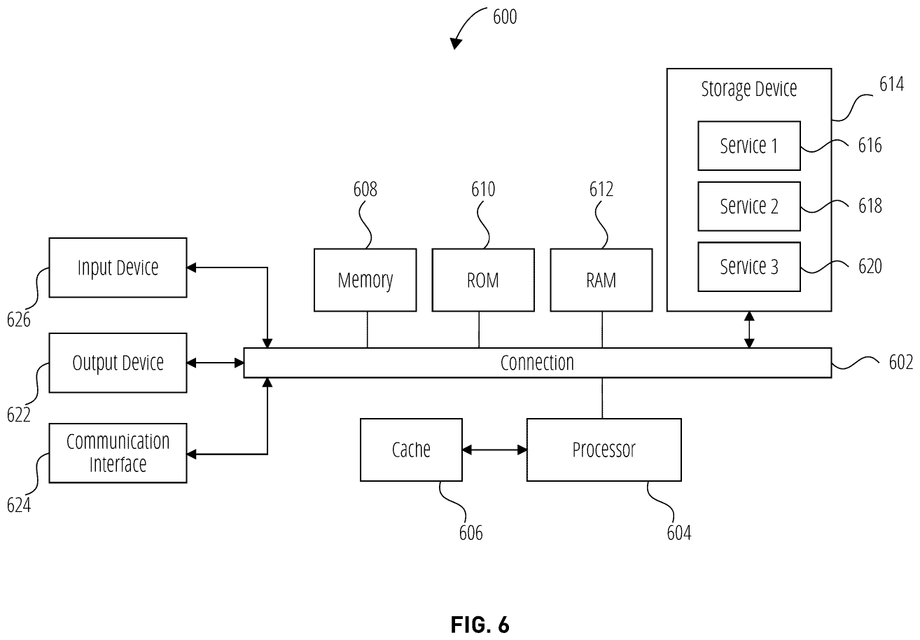

FIG. 6 shows an example of computing system 600, which can be for example any computing device making up the UEDs disclosed herein (e.g., UEDs 120a, 120b, 120c, and 120d), the APs disclosed herein (e.g., RAP 111, and the MAPs 112), the WLCs (e.g., WLC 130 and WLC 202), the switches, and the routers 208, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) processor 604 and connection 602 that couples various system components including system memory 608, such as read-only memory (ROM) 510 and random access memory (RAM) 512 to processor 604. Computing system 600 can include a cache of high-speed memory cache 606 connected directly with, in close proximity to, or integrated as part of processor 604.

Processor 604 can include any general-purpose processor and a hardware service or software service, such as services 516, 518, and 520 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a network devices and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data thatsolid-state cause or otherwise configure a general-purpose computer, special-purpose computer, or special-purpose processing device to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of metering data flows within a wireless mesh-tree network having a root access point (RAP) and mesh access points (MAPs) including a first set of the MAPs at a one-hop level and a second set of the MAPs at a two-hop level, the method comprising:
allocating, by a controller, available data rates (ADRs) for the respective MAPS, wherein, for each of the MAPs, the ADR allocated to a given MAP is a predefined fraction of a total ADR of the RAP; and
apportioning, at a given MAP, the ADR allocated to the given MAP based on an origination type of data flowing through the given MAP, wherein a first portion of the ADR of the given MAP is designated for a first origination type and a second portion of the ADR of the given MAP is designated for a second origination type.

2. The method of claim 1, further comprising:
apportioning, at the given MAP, the ADR allocated to the given MAP by:
determining a first number of tokens that are allocated for the first origination type and a second number of tokens that are allocated for a second origination type; and
transmitting data through the given MAP by:
limiting an amount of data of the first origination type flowing through the given MAP to less than or equal to the first number of tokens, and
limiting an amount of data of the second origination type flowing through the given MAP to less than or equal to the second number of tokens.

3. The method of claim 1, further comprising:
apportioning, at the given MAP, the ADR allocated to the given MAP among three origination types of data, which are (1) a backhaul (BH) data type, (2) an ethernet-bridged data type, and (3) a client data type, the ADR of the given MAP being apportioned by:
providing, at predefined times, a first number of tokens for the BH data type, a second number of tokens for the control data type, and a third number of tokens for the client data type;
limiting, during a predefined time period, an amount of BH data transmitted through the given MAP to be less than or equal to the first number of tokens;
limiting, during the predefined time period, an amount of ethernet-bridged data transmitted through the given MAP to be less than or equal to the second number of tokens; and
limiting, during a predefined time period, an amount of client data transmitted through the given MAP to be less than or equal to the third number of tokens.

4. The method of claim 1, further comprising:
transmitting the data through the given MAP by metering data packets in accordance with the apportionment of the ADR allocated to the given MAP; and
assigning the metered data packets to WiFi multi-media (WMM) based access classes to shape data traffic, and labeling topology maintenance traffic with a predefined WMM based access class that ensures the topology maintenance traffic is fed directly into a WMM queue.

5. The method of claim 1, further comprising:
shaping traffic within the wireless mesh tree by assigning topology maintenance data traffic to an access class that ensures that the topology maintenance data traffic will be fed directly into a data queue.

6. The method of claim 1, wherein the predefined fraction of the total ADR of the RAP that is allocated as the ADR of the given MAP is determined based, at least in part, on a hop level of the given MAP, a number of neighbors of the given MAP, and a number of clients within the wireless mesh-tree network.

7. The method of claim 1, further comprising:
enforcing, by the given MAP, the allocated ADRs of children of the given MAP by:
communicating to the given MAP the allocated ADRs of children of the given MAP; and
pulling, by the given MAP, respective quantities of data packets from the respective children of the given MAP, the respective quantities of data packets being pulled corresponding to the respective located ADRs of the respective children of the given MAP.

8. The method of claim 7, wherein the allocated ADRs of children of the given MAP are enforced using a request to send/clear to send (RTS/CTS) protocol.

9. The method of claim 7, wherein the quantity of data packets being pulled from a given child is apportioned according to origination types of the data, the origination types comprising a backhaul (BH) data type and a client data type.

10. The method of claim 1, further comprising:
independently pulling data packets between hop levels of the wireless mesh-tree network by:
selectively pulling, at the given MAP, uplink data packets from respective children of the given MAP, and when a pulled child of the given MAP lacks uplink data packets increasing a bandwidth of data packets pulled from another of the children of the given MAP, wherein
the children of the given MAP are access points (APs) or client devices in direct communication with the given MAP that are one hop level below the given MAP.

11. The method of claim 1, further comprising:
recursively pulling data packets between hop levels of the wireless mesh-tree network by:
receiving, at the given MAP, a pulling instruction from a parent access point (AP) of the given MAP, the pulling instruction instructing the given MAP to send a specified quantity of data packets of a specified origination type to the parent AP; and
pulling, in response to the pulling instruction, uplink data packets to the given MAP, the uplink data packets being pulled from one or more children of the given MAP, wherein
the children of the given MAP are access points (APs) or client devices in direct communication with the given MAP that are one hop level below the given MAP.

12. The method of claim 1, further comprising:
class-aware pulling of data packets within the wireless mesh-tree network by:
determining, by the children of the given MAP, portions of the ADRs allocated to the children that are apportioned to respective origination types;
communicating, to the given MAP, the apportionments to the respective origination types of the ADRs allocated to the children; and
enforcing, at the given MAP, the apportionments to the respective origination types of the ADRs allocated to the children by selectively pulling data packets from the children in accordance with the apportionments to the respective origination types of the ADRs allocated to the children.

13. The method of claim 12, further comprising:
receiving an instruction to increase a bandwidth allocated to a predefined class of data; and
increasing a rate of pulling, from the children to the given MAP, data packets corresponding to the predefined class of data.

14. The method of claim 1, further comprising:
reserving portions of the ADRs for the respective MAPs for an origination type of control data, the reserved portions of the ADR being determined to provide sufficient bandwidth for the control data to ensure stable operation of the wireless mesh-tree network.

15. A computing apparatus comprising:
a processor; and
a memory storing instructions that, when executed by the processor, configure the apparatus to:
allocate, by a controller, available data rates (ADRs) for the respective MAPs, wherein, for each of the MAPs, the ADR allocated to a given MAP is a predefined fraction of a total ADR of the RAP; and
apportion, at a given MAP, the ADR allocated to the given MAP based on an origination type of data flowing through the given MAP, wherein a first portion of the ADR of the given MAP is designated for a first origination type and a second portion of the ADR of the given MAP is designated for a second origination type.

16. The computing apparatus of claim 15, wherein, when executed by the processor, the stored instructions further configure the apparatus to apportion the ADR allocated to the given MAP by:
determining a first number of tokens that are allocated for the first origination type and a second number of tokens that are allocated for a second origination type; and
transmitting data through the given MAP by:
limiting an amount of data of the first origination type flowing through the given MAP to less than or equal to the first number of tokens, and
limiting an amount of data of the second origination type flowing through the given MAP to less than or equal to the second number of tokens.

17. The computing apparatus of claim 15, wherein, when executed by the processor, the stored instructions further configure the apparatus to:
transmit the data through the given MAP by metering data packets in accordance with the apportionment of the ADR allocated to the given MAP; and
assign the metered data packets to WiFi multi-media (WMM) based access classes to shape data traffic, and labeling topology maintenance traffic with a predefined WMM based access class that ensures the topology maintenance traffic is fed directly into a WMM queue.

18. The computing apparatus of claim 15, wherein, when executed by the processor, the stored instructions further configure the apparatus to:
shape traffic within the wireless mesh tree by assigning topology maintenance data traffic to an access class that ensure that the topology maintenance data traffic will be fed directly into a data queue.

19. The computing apparatus of claim 15, wherein, the predefined fraction of the total ADR of the RAP that is allocated as the ADR of the given MAP is determined based, at least in part, on a hop level of the given MAP, a number of neighbors of the given MAP, and a number of clients within the wireless mesh-tree network.

20. The computing apparatus of claim 15, wherein, when executed by the processor, the stored instructions further configure the apparatus to:
enforce, by the given MAP, the allocated ADRs of children of the given MAP by:
communicating to the given MAP the allocated ADRs of children of the given MAP; and
pulling, by the given MAP, respective quantities of data packets from the respective children of the given MAP, the respective quantities of data packets being pulled corresponding to the respective located ADRs of the respective children of the given MAP.
